(19) United States
(12) Patent Application Publication
(10) Pub. No.: US 2005/0157919 A1
(43) Pub. Date: Jul. 21, 2005

(54) Investigation of destroyed assemblies and identification of components thereof using texture mapping

(76) Inventors: Brenda I. Di Santo, Orlando, FL (US); Bob P. Humeniuk, Orlando, FL (US); Richard D. Bard JR., Rockledge, FL (US); Robert Edwards, Rockledge, FL (US); Alden G. Pitard, Cocoa Beach, FL (US); Kenneth D. Hollifield, Oviedo, FL (US); Danny L. Clark, Cocoa, FL (US); Mia P. Little, Rockledge, FL (US); Jeffery V. Boykin, Satellite Beach, FL (US); Ken L. Edwards, Cocoa, FL (US); David M. Zeiters, Merritt Island, FL (US)

Correspondence Address: THOMPSON COBURN, LLP, ONE US BANK PLAZA, SUITE 3500, ST LOUIS, MO, 63101, US

(21) Appl. No.: 10/898,514

(22) Filed: Jul. 23, 2004

Related U.S. Application Data
(63) Continuation-in-part of application No. 10/631,151, filed on Jul. 31, 2003.

(51) Int. Cl. G06K 9/00; B23P 19/00

(52) U.S. Cl. 382/141; 382/154

(57) ABSTRACT

Methods are disclosed for providing a means for identifying recovered component parts of a destroyed assembly quickly and relatively easily using digital or electronic scanning techniques and comparison to virtual components that are presumed to have constituted the original assembly. The method also provides a means for digitally rigging the component parts in three-dimensional virtual space, thereby minimizing and, in some situations, possibly eliminating any need to physical rig the component parts. The methods include texture mapping a photographic image of a component part onto a representation of the component.

### RELATED APPLICATIONS

This application is a continuation in part of U.S. patent application Ser. No. 10/631,151 filed Jul. 31, 2003 and entitled, “INVESTIGATION OF DESTROYED ASSEMBLIES AND IDENTIFICATION OF COMPONENTS THEREOF.”

### STATEMENT REGARDING FEDERALLY SPONSORED RESEARCH OR DEVELOPMENT

This invention was developed in the course of work under U.S. government contracts GS-23F-0183K and 1970448303 awarded by NASA, Kennedy Space Center. The U.S. government may possess certain rights in the invention.

### BACKGROUND OF THE INVENTION

This invention pertains to methods of investigating accidents or intentional acts leading to the destruction of assemblies. In particular, this invention pertains to the identification of components that previously formed part of an assembled object and to a method of investigating the cause of the destruction of the assembly.

In situations such as an investigation of the cause of an aircraft crash, a detailed reconstruction of the events leading up to the destruction of the aircraft is often conducted. In addition to recorded data and witness knowledge, the recovered components of the aircraft are often useful in identifying the cause of the crash and, in the cases where no recorded data and witness knowledge is available, scrutiny of such components may be the only means of conducting an investigation.

The analysis of the components of a destroyed assembly, such as an aircraft, typically begins by locating and collected recoverable components. In some situations, aircraft crashes in particular, locating the components can be a difficult task due to the fact that such components are often spread out over a very large area. For example, following the destruction of the Space Shuttle Columbia, more than 8,000 separate components of the shuttle were located scattered over hundreds of square miles. As a result of the difficulties associated with locating such components, invariably many components are never located.

For those components located, the next step in an investigation often is to identify each particular component so as to be able to associate the component with a portion of the assembly, as the component was associate therewith prior to the assembly's destruction, and with the remainder of the located components. Typically this involves visual inspection of each component by persons highly familiar with various components of the original assembly who, by such inspection, can identify at least some of the components. In other situations, drawings of the components of the assembly that were created prior to the assembly's destruction are used to aid those attempting to identify the located components. In yet other situations, comparisons are made to physical components of similar undestroyed assemblies. Thus, the task of identifying the located components can, in itself, be tedious and time consuming.

The next step in an investigation typically comprises physically rigging the located components onto a structure in an effort to reconstruct the assembly, at least to the extent possible. When rigging the components, the components are positioned relative to each other in manner emulating their respective original relative positions prior to the destruction of the assembly. The reconstructed portion of the assembly provides investigators with valuable information by allowing them to visualize the various components, and thereby speculate on the possible cause of the assembly's destruction. However, the rigging of the components can be difficult and expensive due to the fact that unique structure is often required to support the components in their relative positions. In some cases, the cost of the structure supporting the rigging, alone, can be extensive. Moreover, rigging often limits the mobility of the components, thereby possibly making it difficult for investigators to obtain desired information from the components. Furthermore, rigging also generally requires a dedicated facility, which can be costly and may reduce or limit the ability of investigators to obtain access to beneficial data. Yet further, the rigging of a component may require physical modification to the component, and may thereby potentially compromise the evidentiary data provided by the component.

In view of the foregoing, it should be appreciated that the reconstruction of a destroyed assembly can be a valuable tool in the investigation of the cause of destruction of such assembly. However, it should also be appreciated that, while advantageous and worthwhile, such reconstruction typically involves numerous steps that are laborious, that require expertise, that consume large periods of time, and that are expensive.

### SUMMARY OF THE INVENTION

The present invention eliminates many of the disadvantages associated with investigations of destroyed assemblies by eliminating the need to perform many of the steps previously required during the reconstruction of such assemblies. Despite the elimination of such steps, the invention nonetheless provides the benefits associated with such prior art reconstructions. In general, the invention provides a means for identifying component parts quickly and relatively easily and provides a means for digitally rigging the component parts in three-dimensional virtual space, thereby minimizing any need to physical rig the component parts. Yet further, the digital or electronic rigging of the reconstructed assembly enhances the ability to investigate the component parts.

A first embodiment of a method of practicing the invention pertains to a method of analyzing a cause of destruction of an assembly. This method generally comprises obtaining first and second components that formed part of the assembly when the assembly was in the assembled condition, producing an electronic representation of a three-dimensional surface contour of at least part of each of the first and second components, producing an electronic representation of a portion of the assembly in three-dimensional virtual space, and analyzing the cause of destruction of the assembly via the representation of the portion of the assembly. The first and second components have been separated from the assembly and from each other as a result of the assembly being destroyed by the cause of destruction and had an original relative position between each other prior to the assembly being destroyed. The electronic representations of a three-dimensional surface contours of the first and second components are produced by obtaining measurements of each of the first and second components using a surface contour scanning device. A photograph of a section of the first component is obtained and textured mapped onto the surface contour of the first component. The electronic representation of the portion of the assembly incorporates the representations of the three-dimensional surface contours of the first and second components with the surface contours positioned relative to each other in the virtual space in a manner based on the original relative position of the first and second components.

A second embodiment of a method of practicing the invention pertains to a method of identifying a component of a dismantled assembly. Prior to being dismantled, the assembly was in an assembled condition. This method generally comprises obtaining an electronic database of properties of a plurality of components that are presumed to have been part of the assembly when the assembly was in the assembled condition, retrieving a physical component that has been dismantled and separated from the assembly, identifying a property of the physical component by obtaining measurements of the physical component, and correlating the physical component to one of the plurality of components by matching the property of the physical component to one of the properties of the plurality of components of the database. The properties of the plurality of components in the database are based at least in part on geometry that the plurality of components are presumed to have had when the assembly was in the assembled condition. The property of the physical component is identified by obtaining measurements of the physical component and by producing an electronic representation of a three-dimensional surface contour of a portion of the physical component based on the measurements. A photograph of a section of the physical component is obtained and textured mapped onto the surface contour of the physical component.

While the principal advantages and features of the invention have been described above, a more complete and thorough understanding of the invention may be obtained by referring to the drawing and the detailed description of the preferred embodiment which follow.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a method in accordance with a preferred embodiment of the present invention.

### DETAILED DESCRIPTION OF THE PREFERRED EMBODIMENTS

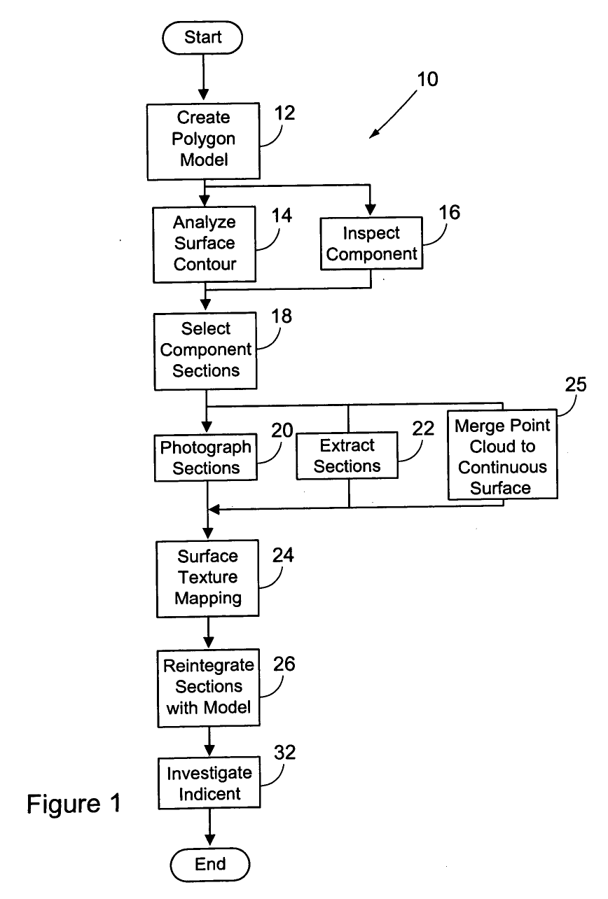

Referring to the accompanying drawings in which like reference numbers indicate like elements, FIG. 1 illustrates a method in accordance with a preferred embodiment of the present invention. The method 10 includes selecting sections of the surface of a component from a disassembled assembly, photographing the selected sections, and surface texture mapping the photographs to the representations of the sections. To the extent the term “section” is used in the claims or is added by amendment, such term should be construed as meaning some or all of the surface of the item or element that it qualifies. A component, therefore, may have a surface of one, or more, three dimensional sections.

Typically, the method 10 begins with the creation of a three-dimensional representation of one or more components from the disassembled assembly as shown at operation 12 of FIG. 1. The creation of the representation generally proceeds as disclosed in co-owned, co-pending application U.S. patent application Ser. No. 10/631,151 entitled, “INVESTIGATION OF DESTROYED ASSEMBLIES AND IDENTIFICATION OF COMPONENTS THEREOF” which is incorporated herein as if set forth in full. The resulting representation of the component is analyzed, or the component itself is inspected, to identify sections of the component for further processing in accordance with the present invention. See operations 14 and 16. It has been found particularly useful to identify those sections of the components that have somewhat planar surface sections. In other words, the representation of the component may be analyzed to identify those sections where the surface orientation at any point does not vary from the general orientation of the particular section by more than a threshold amount, preferably about 10 degrees. The analysis can readily be performed by calculating the normal vector of the surface contour across the component and examining the resulting set of vectors for deviations from one another, an average orientation, or other criteria greater than the threshold amount. From either the analysis of the representation, or the inspection of the component, the most suitable sections of the component are selected in operation 18 for further processing.

In operation 20 photographic images of the selected sections are obtained. Preferably, the camera, or machine vision device, used to obtain the photographic images is orientated so that the photographic images are taken perpendicular to the general orientation of the section being photographed. In the alternative, it will sometimes occur that a component is photographed from a different point of view (relative to the section) before an analysis per operations 14 or 16 can occur. For instance, if the component is located in an area that is difficult to access, some recovery teams may choose to photograph the object in situ rather than retrieving it for subsequent study. In the alternative, the component may have been lost during the mishap (e.g. the component falls into deep water) with the only remaining pertinent evidence being a photograph of the component as it was separating from the assembly, or at some time thereafter. In these situations, photographs of the component taken shortly before the disassembly can be used instead of photographic images taken thereafter. The use of such pre-disassembly photographic images can be highlighted to avoid giving the impression that the section suffered no damage (beyond that damage already evident) during, or after, the disassembly.

The identified sections can be extracted from the representation in operation 22 prior to the texture mapping operation (operation 24 to be discussed), although in a preferred embodiment the sections need not be extracted from the representation. The photographic images of the sections are texture mapped to the surface contours of the corresponding component sections as in operation 24. It has been found that, depending on the software application used to manipulate the representation and/or the surface textures (i.e. the photographic images), improper mapping may occur. In particular it was determined that certain types of files (e.g. compressed surface model files) cause the surface textures to be represented by discrete triangular representations of three points of the point cloud. If an attempt is made to map a photographic image to a section, surface, or component in such representations, the photographic image might be mapped to one, and only one of the triangular representations. Accordingly, a preferred embodiment of the present invention provides for transforming the set of discrete triangles into one continuous polygon that represents the surface of the component or a section thereof. See operation 25. Thus, when the photographic image is subsequently mapped to the surface in operation 24, the image maps to the continuous representation (i.e. the polygon) rather than to any one discrete triangle. After the surface texture mapping, any sections that were extracted from the representation (in operation 22) can be re-integrated with the overall three-dimensional representation as in operation 26. The three dimensional representation of the component, with the surface texturing mapped thereto, is then placed in the virtual space, or otherwise presented to the user, for further investigation of the incident. See operation 32.

In view of the foregoing, it will be seen that the several advantages of the invention are achieved and attained. In particular, the three-dimensional representation of the assembly includes more information regarding the condition of the components following the incident then heretofore available, namely the representation contains the appearance of the components. Additional tools and methods are provided whereby the investigators can identify components of the assembly. Further, because the present invention provides for minimizing the distortion of the photographic image as it is surface texture mapped to the section, the information conveyed by the photographic image is preserved and more accurately presented to the investigators.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method of analyzing a cause of destruction of an assembly, the assembly having an assembled condition at a point in time prior to being destroyed, the method comprising:
obtaining first and second components that formed part of the assembly when the assembly was in the assembled condition and that have been separated from the assembly and each other as a result of the assembly being destroyed by the cause of destruction, the first and second components having an original relative position prior to the assembly being destroyed, the original relative position being that which the first and second components shared relative to each other when the assembly was in the assembled condition;
producing a continuous electronic representation of a three-dimensional, surface contour of at least a part of each of the first and second components by obtaining measurements of each of the first and second components using a surface contour scanning device;
producing an electronic representation of a portion of the assembly in three-dimensional virtual space, the representation of the portion of the assembly incorporating the representations of the three-dimensional surface contours of the first and second components with the surface contours positioned relative to each other in the virtual space in a manner based on the original relative position of the first and second components;
analyzing the cause of destruction of the assembly via the representation of the portion of the assembly;
obtaining at least one photographic image of a visual appearance of the surface of at least a section of the first component; and
texture mapping the photographic image onto a section of the representation of the three-dimensional surface contour of the first component corresponding to the section of the first component, the step of analyzing the cause of destruction of the assembly comprising visual analysis of the representation of the three-dimensional surface contour of the section with the texture mapping thereon.

2. A method in accordance with claim 1, further comprising analyzing the surface contour of the first component to identify the section of the first component.

3. A method in accordance with claim 1, further comprising selecting the section of the first component in a manner so that substantially all of the surface contour of the section of the first component is parallel to the general orientation of the surface contour of the section of the first component to within about 10 degrees.

4. A method in accordance with claim 3, the obtaining at least one photographic image further comprises obtaining the photographic image from a direction substantially perpendicular to the section of the first component.

5. A method in accordance with claim 1, further comprising cropping an area from the photographic image of the section of the first component, the area of the photographic image to correspond to a second section adjacent to the first section of the component of the first component.

6. A method in accordance with claim 1, the obtaining at least one photographic image further comprises obtaining a photographic image of a visual appearance of substantially the entire first component.

7. A method in accordance with claim 1, further comprising extracting the surface contour of the section of the first component from the electronic representation.

8. A method in accordance with claim 7, further comprising reintegrating the surface texture mapped surface contour of the section of the first component with the electronic representation.

9. (canceled)

10. A method of identifying a component of a dismantled assembly, the assembly having an assembled condition at a point in time prior to being dismantled, the method comprising:
obtaining an electronic database of properties of a plurality of components that are presumed to have been part of the assembly when the assembly was in the assembled condition, the properties being properties that are based at least in part on geometry that the plurality of components are presumed to have had when the assembly was in the assembled condition;
retrieving a physical component that has been dismantled and separated from the assembly;
identifying a property of the physical component by obtaining measurements of the physical component and by producing a continuous electronic representation of a three-dimensional surface contour of a portion of the physical component based on the measurements; and
correlating the physical component to one of the plurality of components by matching the property of the physical component to one of the properties of the plurality of components of the database, whereby the component of the dismantled assembly is identified;.
obtaining at least one photographic image of a visual appearance of a surface of at least a section of the physical component that corresponds to a section of the represented surface contour of the physical component; and
texture mapping the photographic image onto the represented surface contour of the section.

11. A method in accordance with claim 10, further comprising analyzing the surface contour of the component to identify the section.

12. A method in accordance with claim 10, further comprising selecting the section of the physical component in a manner so that substantially all of the surface contour of the section is parallel to the general orientation of the surface contour of the section to within about 10 degrees.

13. A method in accordance with claim 12, the obtaining at least one photographic image further comprises obtaining the photographic image from a direction substantially perpendicular to the section.

14. A method in accordance with claim 10, further comprising cropping an area from the photographic image of the section, the area of the photographic image to correspond to a second section adjacent to the first section of the physical component.

15. A method in accordance with claim 10, the obtaining at least one photographic image further comprises obtaining a photographic image of the visual appearance of substantially the entire physical component.

16. A method in accordance with claim 10, further comprising extracting the surface contour of the section from the electronic representation.

17. A method in accordance with claim 16, further comprising reintegrating the surface texture mapped surface contour of the section with the electronic representation.

18. (canceled)

19. A method of identifying a component of a dismantled assembly, the assembly having an assembled condition at a point in time prior to being dismantled, the method comprising:
obtaining an electronic database of properties of a plurality of components that are presumed to have been part of the assembly when the assembly was in the assembled condition, the properties being properties that are based at least in part on geometry that the plurality of components are presumed to have had when the assembly was in the assembled condition;
retrieving a physical component that has been dismantled and separated from the assembly;
identifying a property of the physical component by obtaining measurements of the physical component and by producing a continuous electronic representation of a three-dimensional surface contour of a portion of the physical component based on the measurements;
correlating the physical component to one of the plurality of components by matching the property of the physical component to one of the properties of the plurality of components of the database;
retrieving a second physical component that has been dismantled and separated from the assembly;
identifying a property of the second physical component by obtaining measurements of the second physical component and by producing an electronic representation of a three-dimensional surface contour of a portion of the second physical component based on the measurements of the second physical component;
correlating the second physical component to a second one of the plurality of components by matching the property of the second physical component to one of the properties of the plurality of components of the database;
obtaining at least one photographic image of a visual appearance of a section of the second physical component that corresponds to at least a section of the represented surface contour of the second physical component;
texture mapping the photographic image of the visual appearance of the section of the second physical component onto the section of the represented surface contour of the second physical component;
creating a digital representation of a portion of the assembly in virtual three-dimensional space, the digital representation of the assembly including the represented surface contours of the first and second physical components oriented relative to each other in the virtual space in a manner based on a presumed relative orientation that the first and second physical components are believed to have had when the assembly was in the assembled condition; and
displaying the represented portion of the assembly on a monitor, the displaying showing the texture mapping of the represented surface contour of the section of the second component.

20. A method in accordance with claim 19, further comprising analyzing the surface contour of the second component to identify the section.

21. A method in accordance with claim 19, further comprising selecting the section of the second component in a manner so that substantially all of the surface contour of the section is parallel to the general orientation of the surface contour of the section to within about 10 degrees.

22. A method in accordance with claim 21, the obtaining at least one photographic image further comprises obtaining the photographic image from a direction substantially perpendicular to the section.

23. A method in accordance with claim 19, further comprising cropping an area from the photographic image of the section, the area of the photographic image to correspond to a second section adjacent to the first section of the second component.

24. A method in accordance with claim 19, the obtaining at least one photographic image further comprises obtaining a visual appearance of substantially the entire second component.

25. A method in accordance with claim 19, further comprising extracting the surface contour of the section from the electronic representation.

26. A method in accordance with claim 25, further comprising reintegrating the surface texture mapped surface contour of the section with the electronic representation.

27. (canceled)
